(19) United States
(12) Patent Application Publication
(10) Pub. No.: US 2021/0316561 A1
(43) Pub. Date: Oct. 14, 2021

(54) PRINTER CARRIAGES

(71) Applicant: HEWLETT-PACKARD DEVELOPMENT COMPANY, L.P., Spring, TX (US)

(72) Inventors: Lluis Sole Enrech, Sant Cugat del Valles (ES); Ricardo Oltra Ramirez, Sant Cugat del Valles (ES); Jose Angel Villasante Bembibre, Sant Cugat del Valles (ES); Jose Garcia Martinez, Sant Cugat del Valles (ES)

(73) Assignee: HEWLETT-PACKARD DEVELOPMENT COMPANY, L.P., Spring, TX (US)

(21) Appl. No.: 17/272,845

(22) PCT Filed: Oct. 25, 2018
(86) PCT No.: PCT/US2018/057428

§ 371 Date: Mar. 2, 2021

(51) Int. Cl. B41J 25/304; B41J 11/20; B41J 11/22

(52) U.S. Cl. CPC B41J 25/304; B41J 11/22; B41J 11/20

(57) ABSTRACT

It is disclosed a carriage, e.g., for a printing system comprising a housing being the carriage to move relative to a carriage beam along a scan direction, the carriage comprising: a drive mechanism to move the carriage; and an alignment guide; wherein the alignment guide is parallel to the carriage beam and comprises a first flat surface and a second flat surface and wherein the carriage comprises a plurality of rolling elements including a first rolling element and a second rolling element being the first rolling element to contact the first flat surface and the second rolling element to contact the second flat surface.

### BACKGROUND

In a printing operation of a printing device, a carriage, which includes a print head, is moved relative to a print media item for ejection of print agent from the print head onto the print media item. The carriage may move along a carriage guide and may be propelled along the carriage guide by a drive mechanism. A carriage such as that described above can be employed in printing devices for printing inks and in 3D printing devices wherein layers of build material are selectively solidified by layers with the aid of printing fluids that are printed to the layers of build material.

Similarly, in a scanning operation of a scanning device, which may be included in multifunction printers (MFPs) and other devices, a document to be scanned is placed on a transparent window for scanning. The document may be placed, face down (i.e., where “face” refers to the side of the document to be scanned) on one side of the window. A carriage, which has coupled thereto a scan bar including optics for scanning the document, may then be moved along the length of the opposite side of the window, e.g., along a carriage rod. The carriage, and thus the scan bar, may be propelled along the carriage rod by a drive mechanism that includes a motor and a flexible belt.

### BRIEF DESCRIPTION OF THE DRAWINGS

Various example features will be apparent from the detailed description which follows, taken in conjunction with the accompanying drawings, wherein:

FIG. 1 shows a cross-section view of an example of a carriage, in this case, for carrying a printhead of a printing system.

FIG. 2 shows a detail view of the guide and the slider of FIG. 1.

FIG. 3 shows a perspective view of a carriage according to an example.

FIG. 4 illustrates mechanical movements of the carriage to calibrate a carriage according to an example.

### DETAILED DESCRIPTION

In the following description and figures, some example implementations of print apparatus, print systems, and/or printers are described. In examples described herein, a “printer” or a “printing system” may be a device comprising a carriage being the device to print content to a physical medium (e.g., paper, textiles, a layer of powder-based build material, etc.) with a print material (e.g., ink or toner). For example, the printer may be a wide-format print apparatus that prints latex-based print fluid on a print medium, such as a print medium that is size A2 or larger. In some examples, the physical medium printed on may be a web roll or a pre-cut sheet. In the case of printing on a layer of powder-based build material, the print apparatus may utilize the deposition of print materials in a layer-wise additive manufacturing process. A printer may utilize suitable print consumables, such as ink, toner, fluids or powders, or other raw materials for printing. In some examples, a print apparatus may be a three-dimensional (3D) print apparatus. An example of fluid print material is a water-based latex ink ejectable from a print head, such as a piezoelectric print head or a thermal inkjet print head. Other examples of print fluid may include dye-based color inks, pigment-based inks, solvents, gloss enhancers, fixer agents, and the like. Also, the printer may comprise a carriage associated to a scanning device wherein the scanner is to acquire content from a physical medium and store it in a digital format.

In one example, the present disclosure describes a carriage for use in a printer side of a printing system, i.e., the part of the printing system associated to printing content in a physical medium. However, in another example, the carriage of the present disclosure can be incorporated in a scanning device associated to the printing system.

The carriage disclosed herein comprises a drive mechanism that is used to propel the carriage along a drive direction, the carriage may comprise a coupled a print head, when printing a document. In the present disclosure, the carriage may comprise a motor fixedly attached to the carriage, i.e., that moves jointly with the carriage along the drive direction or a motor remote from the carriage but mechanically coupled as to move the carriage along the drive direction.

Similarly, in the case of a scanning device, a scan bar may be coupled to a carriage and the scanning device may comprise a drive mechanism that is used to propel the carriage. Such drive mechanism may be fixedly attached to the carriage or mechanically coupled as to move it.

It is therefore hereby disclosed a carriage comprising a housing being the carriage to move relative to a carriage beam along a scan direction, the carriage comprising:
a drive mechanism to move the carriage; and
an alignment guide;
   wherein the alignment guide is parallel to the carriage beam and comprises a first flat surface and a second flat surface and wherein the carriage comprises a plurality of rolling elements including a first rolling element and a second rolling element being the first rolling element to contact the first flat surface and the second rolling element to contact the second flat surface.

In an example, the first flat surface is inclined with respect to the second flat surface, e.g., the first flat surface is orthogonal to the second flat surface.

The alignment guide of an example of carriage according to the present disclosure may be an L-shaped guide having sides wherein the sides of the L define the first flat surface and the second flat surface.

In a further example, the alignment guide is a U-shaped guide wherein two sides of the “U” define the first flat surface and the second flat surface. The third side of the “U” may provide for an attachment surface that is to be attached to the beam.

In other examples, the alignment guide has a rectangular cross-section.

With respect to the manufacturing of the alignment guide, it may be manufactured as a plate having a bend that defines the boundary between the first flat surface and the second flat surface.

In a further example, the carriage may comprise shock-absorbing elements, e.g., the rolling element comprises an elastomeric member.

Furthermore, it is described a printing system comprising:
a print medium support surface to support a print medium:
a carriage comprising a housing to receive a printhead, the printhead comprising a set of nozzles to eject a printing fluid towards the print medium;
a carriage beam that extends along a scan direction;
an alignment guide parallel to a carriage beam; and
a drive mechanism to drive the carriage along the scan direction;
   wherein the alignment guide comprises a first flat surface and a second flat surface being the first and second surface adjacent to one another and arranged angled between them, and wherein the carriage comprises a first rolling element in contact with the first flat surface and a second rolling element in contact with the second flat surface.

In an example, the first flat surface and the second flat surface are orthogonal.

Furthermore, the first flat surface and the second flat surface may be part of an L-shaped or U-shaped guide. In a further example, the alignment guide has a rectangular cross-section.

Also, the system may comprise a third flat surface remote from the alignment guide and the carriage comprising a third rolling element in contact with the third flat surface.

In an example, the first and second rolling elements comprise an elastomeric member, e.g., a rubber or plastic capable to deform and return to its original state as to absorb possible rugosities on the flat surfaces.

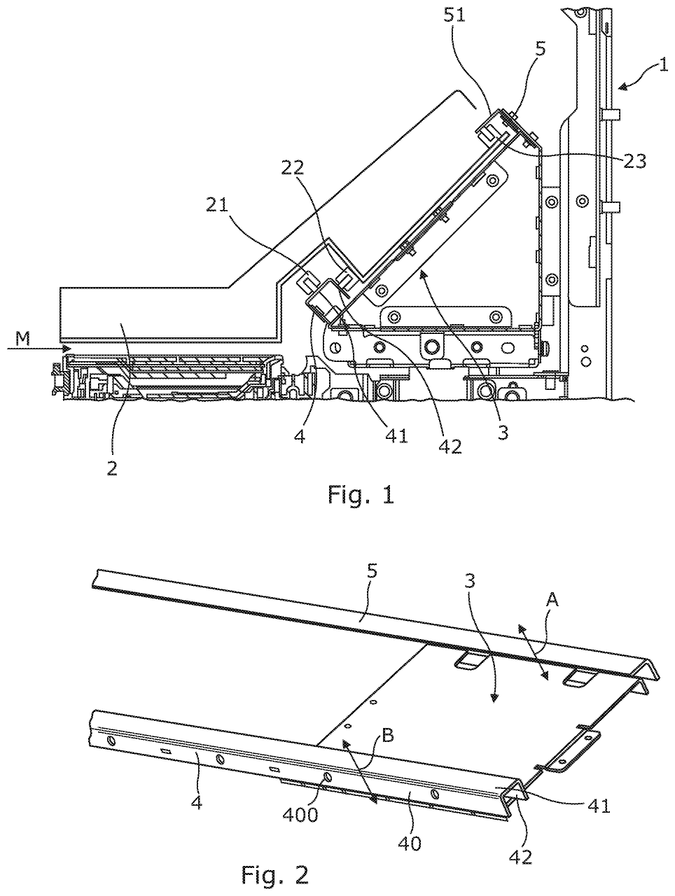

FIG. 1 shows an example of a carriage 2 for use as part of a printing system 1. In the example of FIG. 1, it is shown part of a printing system 1 wherein some elements have been removed to increase the intelligibility of the figure. The printing system comprises a carriage 2 that may house a printing element, e.g., a printhead or, in another example, a scanner. The printing system comprises a beam 3 with a length that defines the travel distance of the carriage 2.

A drive mechanism may be used to propel the carriage. Such drive mechanism may comprise a motor and a flexible belt. A tensioning system may be used to apply a constant force that maintains the proper amount of tension in the belt. In the present disclosure, the motor and the tensioning system may be placed at the same end of the carriage rod, with the tensioning system acting upon a driven pulley coupled to an output of the motor. The tension applied to the belt by the tensioning system may be increased or decreased dependent upon the direction of rotation of the output of the motor to ensure balance of forces on both sides of the belt.

In an example, the carriage 2 may comprise a drive mechanism or an impelling mechanism fixedly attached thereto, i.e., that, in operation, moves together with the carriage 2. The drive mechanism may comprise a motor and a wheel to traction against a respective traction surface coupled to or being part of the beam.

As shown in FIG. 1, the system 1 may also comprise an alignment guide 4 to help maintain the alignment of the carriage 2 with respect to the beam 3. In an example, the alignment guide 4 is partially enclosed by the carriage, being the carriage 2 to slide along the alignment guide 4. In a further example, the beam 3 may also comprise a slider 5 remote from the alignment guide 4 that acts as a further guiding mechanism for the carriage 2 along its movement.

The alignment guide 4 of FIG. 1 is a U-shaped guide that has three flat surfaces defined by the sides of such a U-shape, a first flat surface 41, a second flat surface 42 and an attachment surface that is to be attached to the beam 3. The first flat surface 41 is to cooperate with a first rolling element 21 provided on the carriage and is positioned to slide along the first flat surface 41. Likewise, the second flat surface 42 is to cooperate with a second rolling element 22 provided on the carriage and is to slide along the second flat surface. In a further example, the alignment may be an L-shaped guide wherein each of the sides of the “L” provides for a flat surface 41, 42.

One of the features of the alignment guide 4 is to be able to maintain the alignment of the carriage in two directions, a scanning direction, i.e., the direction along the beam 4, and a media advance direction (M) perpendicular to the scanning direction. The alignment guide 4 achieves this feature by providing that the first flat surface 41 and the second flat surface 42 are provided adjacent and at an angle. In the example of FIG. 1, the first flat surface 41 is orthogonal to the second flat surface 42, however, in other examples, the angle between the flat surfaces may differ and may preferably be between 30° and 90°. The inclination between the surfaces may be achieved by using a bent plate or profile as alignment guide 4 so that a bend defines the transition between the flat surfaces 41, 42.

The slider 5, may also be a U-shaped or L-shaped profile attached to the beam 3 as to provide a stepped surface having an upper surface 51 separated from the beam by a distance defined by the length of the profile and an attachment surface that is to be attached to the beam 3. In an example, the carriage 2 comprises a third rolling element 23 that is to cooperate with the upper surface 51 so that the rolling element slides along such upper surface 51, therefore, such upper surface 51 may act as a third flat surface for sliding of the carriage 2.

FIG. 2 shows a detail of FIG. 1 wherein the beam 3, the alignment guide 4 and the slider 5 are shown in more detail. FIG. 2 shows that the attachment side 40 of the U-shaped alignment guide 4 comprises a slot 400 that is to receive a fixing element, e.g., a screw to fix the alignment guide 4 to the beam 3. The slot 400 may provide for different positions of the alignment guide 4 with respect to the beam 3 and, in particular, different separations distances between the beam and the alignment guide 4. Also. Similarly, the slider 5 may be provided with a slot that defines the distance between the upper surface 51 and the beam.

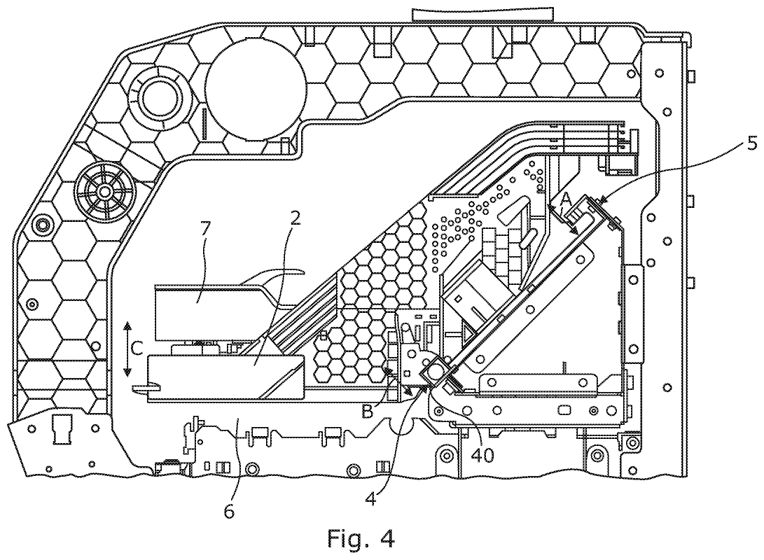

Such slots may be used in a calibration of the pen-to-reference space, i.e., the distance and parallelism between a printhead that is to be housed by the carriage 2 and a reference, e.g., a platen on the printing system 1 or a media that is to be printed. In an example the alignment guide may move along a first calibration direction (A) and the slider 5 may move along a second calibration direction (B) and the slots provide for such movements. Such calibration will be explained in more detail with reference to FIG. 4.

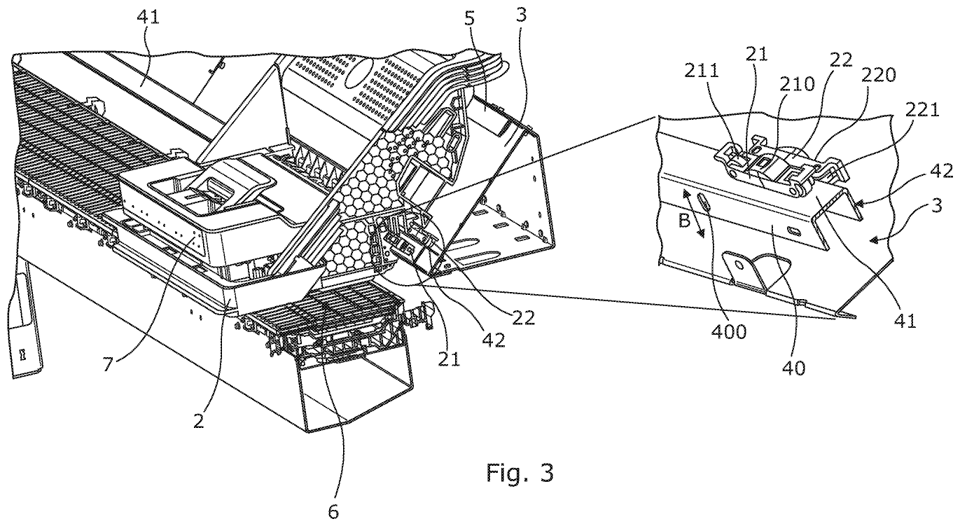

FIG. 3 shows an example of carriage for a printing system 1 according to an example. In the example of FIG. 3, it is shown that a printhead 7 may be detachably engaged to the carriage 2 as to move together with it. The printhead 7 may be defined, in general terms, as a controllable fluid ejection device that propels droplets of printing fluid from a nozzle to form an image on a substrate wherein such propelling can be achieved by different technologies such as, e.g., thermal injection or piezo injection.

The carriage 2 is to move along the beam 3 in a scanning direction thereby defining the position of the printhead 7 along the width of a media to be printed. As mentioned above, in order to achieve an accurate position of the droplets along the width of the media a calibration proceeding may be performed wherein the alignment between the printhead 7 and a reference surface, e.g., a platen 6 and its parallelism may be calibrated by the movement of the alignment guide 4 and/or the slider 5.

Furthermore, as can be seen in the detail of the rightmost side of the figure, the alignment bar 4 comprises a first flat surface 41 along which a first rolling element 21 is provided and a second flat surface 42 along which a second rolling element 22 is provided. The first and second flat surfaces being angled between them and the rolling elements being to slide along the flat surfaces in a scanning direction. The rolling elements 21, 22 may each be provided with a housing 210, 220 and a set of wheels 211, 221. In the example of FIG. 3 each rolling element comprises two wheels. Also, the carriage may comprise multiple first rolling elements and multiple second rolling elements depending on the size and weight of the carriage 2.

In an example, the rolling elements 21, 22 may be provided with shock-absorption capabilities. To accomplish the shock absorption, the rolling elements 21, 22, may be provided with an elastomeric component that helps dampen noise due, e.g., to rugosities on the flat surfaces 41, 42. In an example, the housing 210, 220 may be made of an elastomeric material, e.g., a plastic or rubber. In a further example, the wheels, 211, 221 may be made of an elastomeric material, e.g., a plastic or rubber. Such elastomeric material within the rolling elements 21 provides for shock absorption in the sliding movement of the carriage along the guide and help absorb possible rugosities or imperfections of the alignment guide 4.

In another example, the rolling elements 21, 22, may be provided of an additional elastomeric member. Such members can include, amongst others, springs, gas canisters, or any element capable of recovering size and shape after a deformation, for example, a deformation caused by a compressing force.

Another manner of accomplishing low noise due to the sliding movement of the carriage may be to provide a coating on the flat surfaces 41, 42 as to remove their rugosities. Examples of such coatings may be a chromed coating.

FIG. 4 illustrates possible mechanical movements that may be performed on a carriage 2 according to the present disclosure as to achieve its calibration. The calibration may comprise determining the pen-to-reference space.

In an example, the alignment guide 4 and the slider 5 may be provided with a movement capability so that they may be attached to the beam at different relative distances thereto. For example, the slider 5 may be provided with a range of possible attachment positions along a slot, thereby providing with a first calibration movement along a first calibration direction (A). Likewise, the alignment guide 4 may be provided with a slotted attachment to the beam 3 so that the alignment guide may move along a second calibration direction (B) and attached at several attachment points along such direction, i.e., at different positions within the slot.

Such different locations along the first calibration direction (A) and the second calibration direction (B) may help determine the pen-to-reference position, i.e., the position of the printhead 7 along the printhead calibration direction (C) including the inclination of the printhead with respect to a reference 6.

In an example calibration of the pen-to-reference space, i.e., the distance along the printhead calibration direction (C), a user defines the distance along the second calibration direction (B) at a determined attachment point between the beam 3 and the alignment guide 4, thereby defining a datum reference for the pen-to-reference spacing. Once the attachment between the alignment guide 4 and the beam 3 has been defined, the user may determine the distance along the first calibration direction (A), this distance may define the parallelism between the carriage 2 and the platen 6, i.e., adjust the heading of the printhead 7.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teachings. It is to be understood that any feature described in relation to any one example may be used alone, or in combination with other features described, and may also be used in combination with any features of any other of the examples, or any combination of any other of the examples.

1. A carriage comprising a housing being the carriage to move relative to a carriage beam along a scan direction, the carriage comprising:
a drive mechanism to move the carriage; and
an alignment guide;
wherein the alignment guide is parallel to the carriage beam and comprises a first flat surface and a second flat surface and wherein the carriage comprises a plurality of rolling elements including a first rolling element and a second rolling element being the first rolling element to contact the first flat surface and the second rolling element to contact the second flat surface.

2. The carriage of claim 1, wherein the first flat surface is inclined with respect to the second flat surface.

3. The carriage of claim 1, wherein the first flat surface is orthogonal to the second flat surface.

4. The carriage of claim 3, wherein the alignment guide is an L-shaped guide having sides wherein the sides of the L define the first flat surface and the second flat surface.

5. The carriage of claim 3, wherein the alignment guide is a U-shaped guide wherein two sides of the U define the first flat surface and the second flat surface.

6. The carriage of claim 1, wherein the alignment guide has a rectangular cross-section.

7. The carriage of claim 1, wherein the alignment guide is a plate having a bend that defines the boundary between the first flat surface and the second flat surface.

8. The carriage of claim 1, wherein the rolling element comprises an elastomeric member.

9. A printing system comprising:
a print medium support surface to support a print medium;
a carriage comprising a housing to receive a printhead, the printhead comprising a set of nozzles to eject a printing fluid towards the print medium;
a carriage beam that extends along a scan direction;
an alignment guide parallel to a carriage beam; and
a drive mechanism to drive the carriage along the scan direction;
wherein the alignment guide comprises a first flat surface and a second flat surface being the first and second surface adjacent to one another and arranged angled between them, and wherein the carriage comprises a first rolling element in contact with the first flat surface and a second rolling element in contact with the second flat surface.

10. The system of claim 9, wherein the first flat surface and the second flat surface are orthogonal.

11. The system of claim 9, wherein the first flat surface and the second flat surface are part of an L-shaped guide.

12. The system of claim 9, wherein the first flat surface and the second flat surface are part of a U-shaped guide.

13. The system of claim 9, wherein the alignment guide has a rectangular cross-section.

14. The system of claim 9, further comprising a third flat surface remote from the alignment guide and the carriage comprising a third rolling element in contact with the third flat surface.

15. The system of claim 9, wherein the first and second rolling elements comprise an elastomeric member.
